(19) United States
(12) Patent Application Publication
(10) Pub. No.: US 2019/0008139 A1
(43) Pub. Date: Jan. 10, 2019

(54) GAME CALL APPARATUS

(71) Applicant: Countrymen Innovations LLC, Red Hook, NY (US)

(72) Inventor: Richard A. Wyant, Red Hook, NY (US)

(21) Appl. No.: 15/644,978

(22) Filed: Jul. 10, 2017

(51) Int. Cl. A01M 31/00; A01M 31/06

(52) U.S. Cl. CPC A01M 31/004; A01M 31/06

(57) ABSTRACT

An apparatus is described with a pair of sidewalls, a handle, sound devices, and a cord. The pair of sidewalls defines a pair of tracks. The handle is located between the pair of sidewalls and is captured in the pair of tracks in a manner that allows the handle to translate in the tracks. The sound devices are located between the pair of sidewalls. The cord passes through the pair of sidewalls and the sound devices. Translating the handle causes the handle to strike one or more of the sound devices and to produce a sound mimicking that of butting deer antlers.

### FIELD OF THE INVENTION

The present invention relates generally to apparatus for use in hunting, and, more particularly, to game calls capable of mimicking the sound of butting antlers.

### BACKGROUND OF THE INVENTION

Deer hunters have determined that striking two antlers together to create the sound of two bucks butting antlers during rut tends to spark the curiosity of nearby deer and attract them towards the sound. Some hunters carry a pair of real deer antlers when hunting and strike them together to create the desired sound. However, carrying deer antlers is often unwieldy because of their size and shape. At the same time, it takes two hands to strike the antlers together, making it more difficult for the hunter to quickly and silently transition to a gun or bow when a deer approaches.

Because of these difficulties, other game calls have been developed that may be utilized to mimic the sounds of striking antlers. These devices are frequently called “rattlers.” U.S. Patent Application Publication No. 2002/0058457 to T. L. Butler and entitled “Game Call Producing Antler Sounds,” for example, describes a system wherein a bundle of stick-like pieces are rubbed together to produce the desired sound. Nevertheless, this device requires two hands to actuate. It is also difficult to remotely actuate this device, meaning that the source of the sound and the hunter are co-located. Accordingly, if a hunter uses this device while in a tree stand, an approaching deer is likely to look up towards the source of the sound and see the hunter.

For the foregoing reasons, there is a need for new game call designs capable of producing the sound of striking antlers while being easily actuated with only one hand as well as remotely actuated.

### SUMMARY OF THE INVENTION

Embodiments of the present invention address the above-identified needs by providing a game call apparatus that can be operated with one hand and that can be remotely actuated.

Aspects of the invention are directed to an apparatus comprising a pair of sidewalls, a handle, a plurality of sound devices, and a cord. The pair of sidewalls define a pair of tracks. The handle is disposed between the pair of sidewalls and is translatably captured in the pair of tracks. The plurality of sound devices are disposed between the pair of sidewalls. The cord passes through the pair of sidewalls and the plurality of sound devices. Translating the handle causes the handle to strike one or more of the plurality of sound devices and produce a sound.

### BRIEF DESCRIPTION OF THE DRAWINGS

These and other features, aspects, and advantages of the present invention will become better understood with regard to the following description, appended claims, and accompanying drawings where:

FIGS. 1 and 2 show top perspective views of a game call apparatus in accordance with an illustrative embodiment of the invention;

FIG. 3 shows a bottom perspective view of the FIG. 1 game call apparatus;

FIG. 4 shows a perspective view of the handle in the FIG. 1 game call apparatus;

FIGS. 5 and 6 show sectional views of the sound devices in the FIG. 1 game call apparatus; and

FIG. 7 shows a side elevational view of the FIG. 1 game call apparatus attached to a tree.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

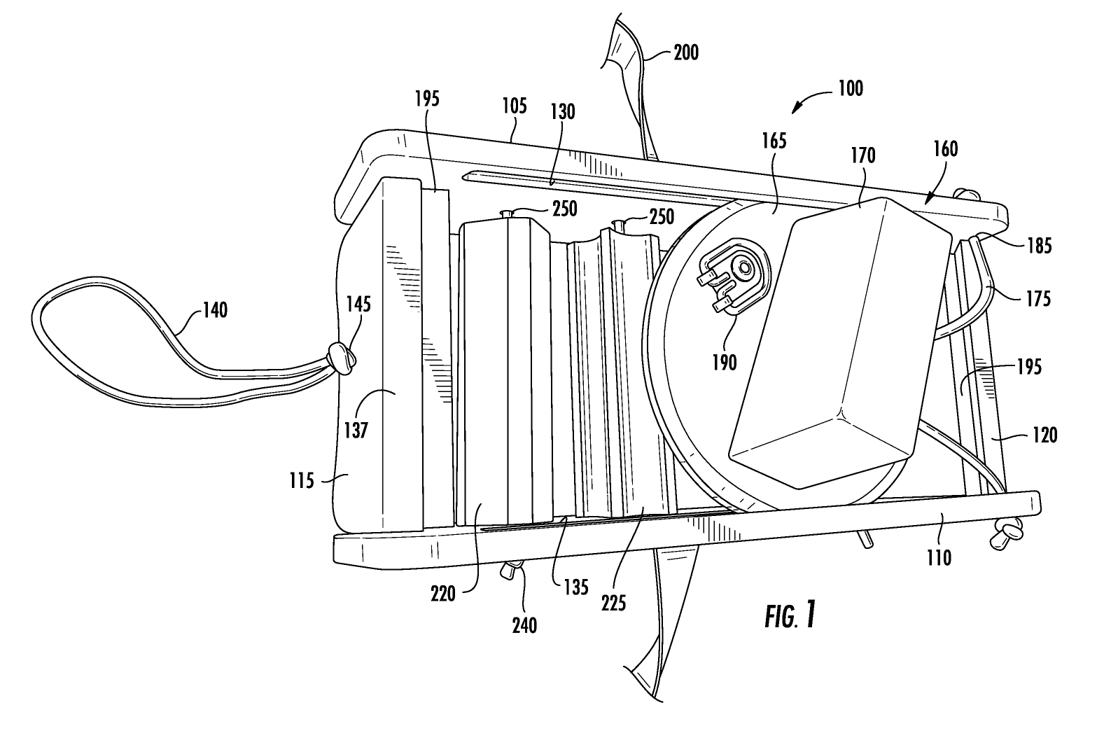

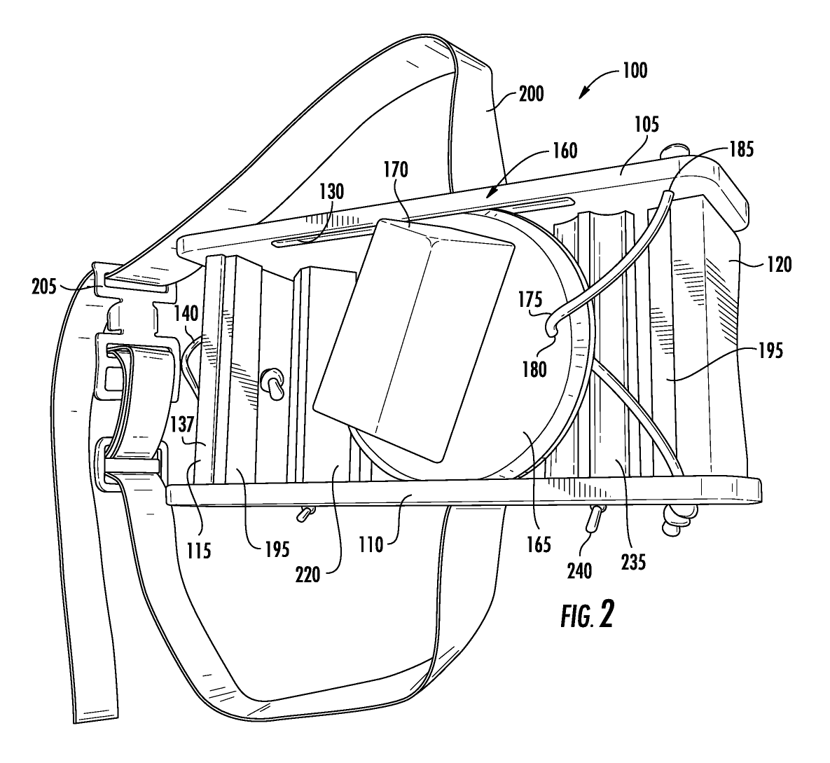

As used herein, the words “substantially parallel” are intended to mean parallel within plus or minus ten degrees. A cord is “elastic” if it is capable of being repeatedly stretched to at least 125% of its relaxed length in response to a manual stretching force provided by a human being of average strength, and then returning to its relaxed length when the manual stretching force is removed. The directional terms “up,” “down,” “top,” “bottom,” “above,” and “below” are in relation to the manner in which the apparatus is oriented in FIGS. 1 and 2.

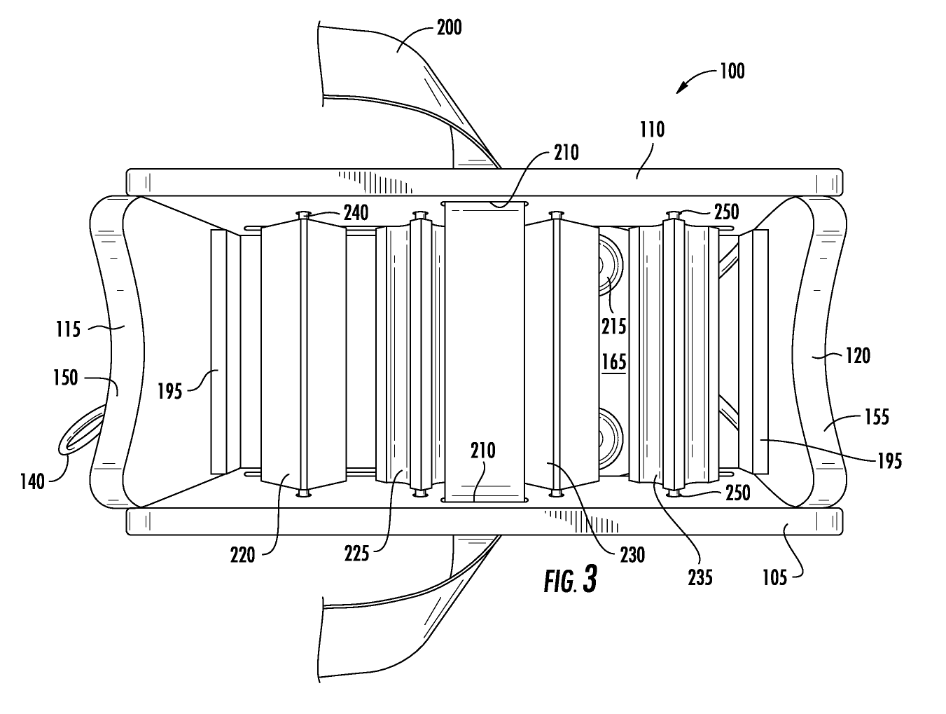

FIGS. 1-3 show aspects of a game call apparatus 100 in accordance with an illustrative embodiment of the invention. FIGS. 1 and 2 show top perspective views, while FIG. 3 shows a bottom perspective view.

The game call apparatus 100 comprises a first sidewall 105 and a second sidewall 110 that is substantially parallel to the first sidewall 105. A first endwall 115 and a second endwall 120 each span between the first and second sidewalls 105, 110 at respective ends of the game call apparatus 100 and are fixated by screws. The first sidewall 105 defines a first track 130, while the second sidewall 105 defines a second track 135. A top edge 137 of the first endwall is about level with the bottom of the first and second tracks 130, 135. A first cord 140 passes through a first hole 145 in the first endwall 115 and is formed into a loop with a knot.

The first and second endwalls 115, 120 have different dimensions from each other. Each of the first and the second endwalls 115, 120 protrudes past the first and second sidewalls 105, 110 (FIG. 3). In so doing, the first endwall 115 projects further past the first and second sidewalls 105, 110 than does the second endwall 120. The first endwall 115 terminates in a first curved edge 150, while the second endwall 120 terminates in a second curved edge 155.

A handle 160 defines a circular plate 165 and a rectangular grasping block 170 that projects upward from the circular plate 165. The circular plate 165 is captured in the first track 130 and the second track 135 in a manner that allows the circular plate 165 to freely translate inside those tracks 130, 135 between the first and second endwalls 115, 120. In this manner, the handle 160 is disposed between the first sidewall 105 and the second sidewall 110, and is translatably captured in the first track 130 and the second track 135. A second elastic cord 175 passes through a second hole 180 in the circular plate 165 and third holes 185 in the first and second sidewalls 105, 110, terminating in two knots. So positioned, the second elastic cord 175, when stretched, biases the handle 160 towards the second endwall 120. A hinged d-ring 190 is attached to the circular plate 165. Two cushioned bumper strips 195 are attached to the first and second endwalls 115, 120, respectively, and prevent the handle 160 from banging into the first and second endwalls 115, 120 when translated. A belt 200 with a buckle 205 passes through slots 210 in the first and second sidewalls 105, 110.

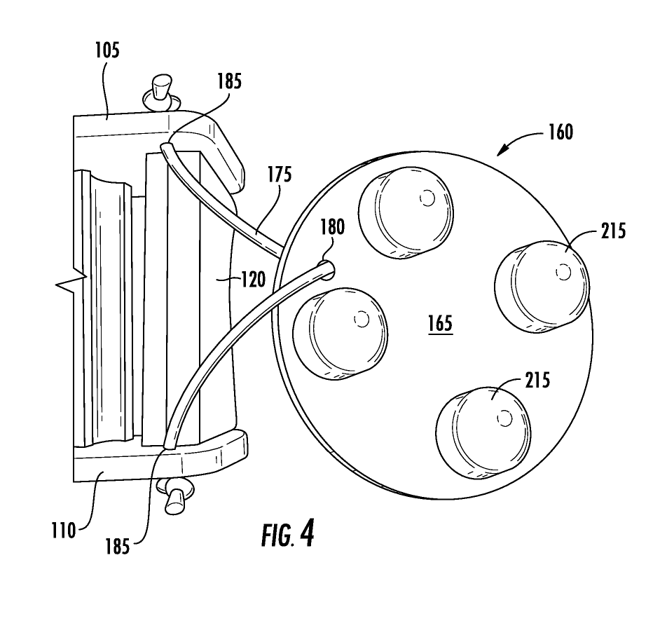

The handle 160 further defines several rounded nubs 215 that protrude from the circular plate 165 opposite the rectangular grasping block 170. These rounded nubs 215 are partially visible in FIG. 3, but better displayed in FIG. 4, which shows a perspective view of the handle 160 with the handle removed from the first and second tracks 130, 135 and flipped over in relation to the orientations in FIGS. 1 and 2. In the present illustrative embodiment, there are four rounded nubs 215 arranged radially about a center of the circular plate 165.

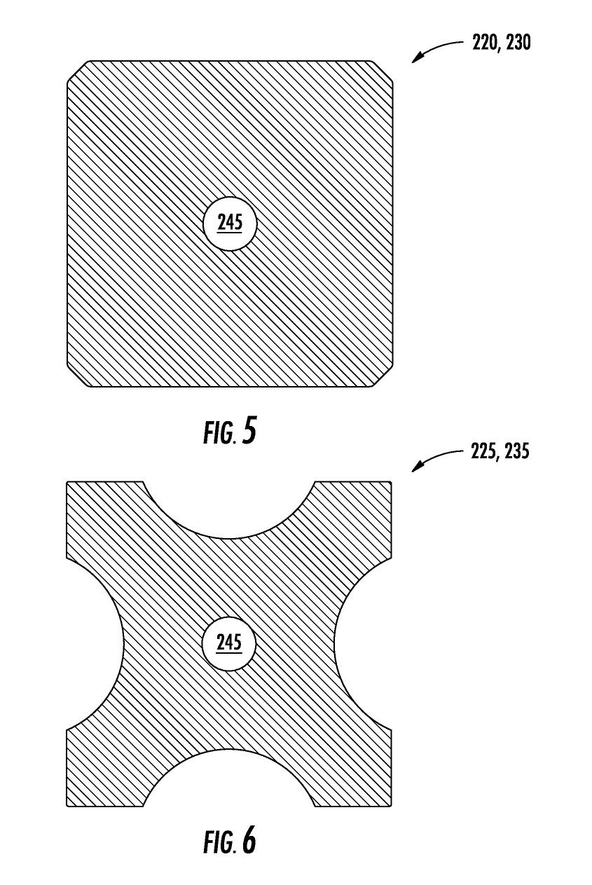

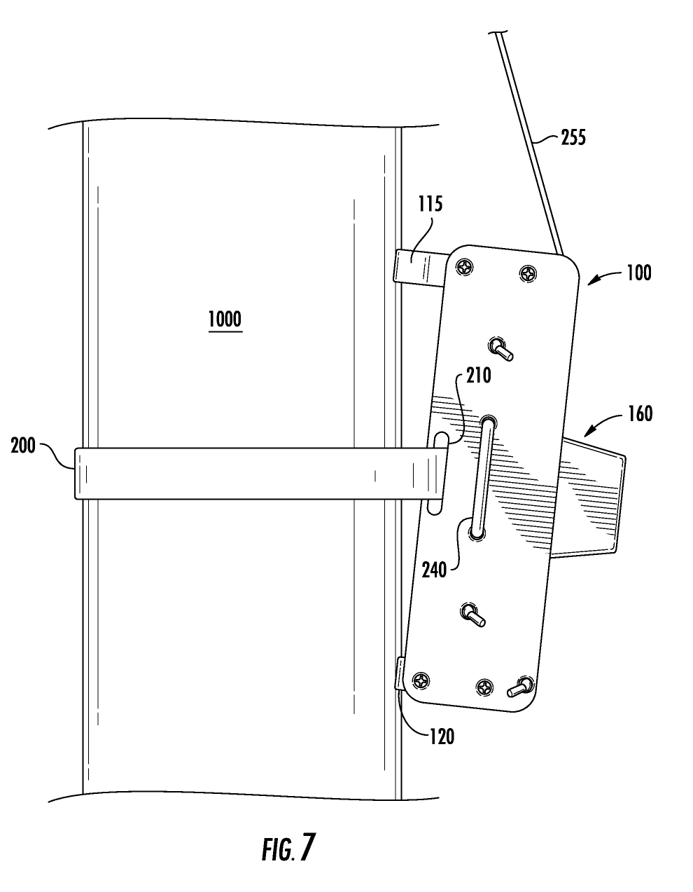

A first sound device 220, a second sound device 225, a third sound device 230, and a fourth sound device 235 are disposed between the first sidewall 105 and the second sidewall 110. In the present illustrative, non-limiting embodiment, the first and third sound devices 220, 230 have a different shape from the second and fourth sound devices 225, 235. Cross-sectional views of the sound devices 220, 225, 230, 235 are shown in FIGS. 5 and 6 with FIG. 5 corresponding to the shape of the first and third sound devices 220, 230, and FIG. 6 corresponding to the shape of the second and fourth sound devices 225, 235. Fixation in these locations is via a third elastic cord 240 (a single, unitary cord) that passes through respective center channels 245 in each of the sound devices 220, 225, 230, 235 and eight fourth holes 250 in the first and second sidewalls 105, 110. The third elastic cord 240 terminates in two knots, one at each end. Arranged in this manner, each portion of the third elastic cord 240 that passes through a sound device 220, 225, 230, 235 is separated from the other such portions.

The several elements of the game call apparatus 100 may be formed of a myriad of different materials. The sidewalls 105, 110, the endwalls 115, 120, and the handle 160 may, for example, be formed of wood or plastic, and one having ordinary skill in the relevant manufacturing arts would recognize how to manufacture these elements given the teachings herein. The elastic cords 140, 175, 240, the hinged d-ring 190, the cushioned bumper strips 195, and the screws may be obtained commercially.

When the handle 160 is rotated and/or translated in the game call apparatus 100, the rounded nubs 215 bang against the sound devices 220, 225, 230, 235 and produce a sound very close to the sound of two antlers striking each other. In the present non-limiting embodiment, the rounded nubs 215 are solid (i.e., not hollow), which helps to create the desired sound. A user may use the game call apparatus 100 with both hands, or if, desired, may actuate the game call apparatus 100 with one hand. The first cord 140 provides a convenient means by which to suspend the game call apparatus 100 for single-handed operation.

Advantageously, the game call apparatus 100 is also designed to be operated remotely, an in particularly, by a hunter occupying a tree stand in a tree. FIG. 7 shows a side elevational view of the game call apparatus 100 mounted to a tree trunk 1000. As indicated in the figure, the first and second curved edges 150, 155 of the first and second endwalls 115, 120 are placed against the tree trunk 1000 while the belt 200 is made to surround the tree trunk 1000 with the second endwall 120 closer to the ground. Because the first and second endwalls 115, 120 protrude from the game call apparatus 100 to different extents, mounting the game call apparatus 100 in this manner causes the game call apparatus 100 to sit at an oblique angle relative to the tree trunk 1000 and the ground. That is, the first and second tracks 130, 135 of the mounted game call apparatus 100 are not oriented vertically.

Once so mounted, the game call apparatus 100 can be operated by connecting an actuation cable 255 to the handle 160 via the hinged d-ring 190 and then pulling the actuation cable 255 to make the handle 160 move in the game call apparatus 100 towards the first endwall 115 and away from the second endwall 120. Since the hinged d-ring 190 is not centered in the handle 160, pulling the actuation cable 255 has the effect of both rotating the handle 160 and translating the handle 160 to produce the desired sound. The non-vertical angle of the game call apparatus 100 also causes the actuation cable 255 to ride over the top edge 137 of the first endwall 115, and to therefore cause the handle 160 to be pulled along the first and second tracks 130, 135 with a slightly downward bias towards the sound devices 220, 225, 230, 235. This angle helps to assure that the rounded nubs 215 of the handle 160 solidly contact the underlying sound devices 220, 225, 230, 235 to produce the desired sound. Releasing the actuation cable 255, in turn, has the effect of allowing the second elastic cord 175 and gravity to return the handle 160 towards the second endwall 20, again producing a sound.

The actuation cable 255 may therefore be pulled and released by a hunter positioned in a tree stand above the mounted game call apparatus 100. The game call apparatus 100 makes the desired sounds remote from the hunter so as to not give away the hunter's location.

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

For example, alternative embodiments of game call apparatus could have handles and/or sound devices with different shapes from those set forth above and the results would still fall within the scope of the invention. In one or more alternative embodiments, for instance, one or more sound devices could be round, hexagonal, octagonal, and the like in cross-section. Moreover, in even one or more alternative embodiments, each of the sound devices on a given game call apparatus could have the same shape, or each of the sound devices could have a different shape.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in AIA 35 U.S.C. § 112(f). In particular, the use of “steps of” in the claims herein is not intended to invoke the provisions of AIA 35 U.S.C. § 112(f).

What is claimed is:

1. An apparatus comprising:
a pair of sidewalls defining a pair of tracks;
a handle disposed between the pair of sidewalls and translatably captured in the pair of tracks;
a plurality of sound devices disposed between the pair of sidewalls; and
a cord passing through the pair of sidewalls and the plurality of sound devices;
wherein translating the handle causes the handle to strike one or more of the plurality of sound devices and produce a sound.

2. The apparatus of claim 1, wherein the handle defines a plurality of nubs.

3. The apparatus of claim 1, wherein each of the plurality of sound devices is elongate.

4. The apparatus of claim 1, wherein the plurality of sound devices comprises two sound devices with different shapes.

5. The apparatus of claim 1, wherein the plurality of sound devices comprises two sound devices with the same shape.

6. The apparatus of claim 1, wherein the cord is elastic.

7. The apparatus of claim 1, further comprising a pair of endwalls spanning between the pair of sidewalls.

8. The apparatus of claim 7, further comprising a pair of cushioned bumpers, each of the pair of cushioned bumpers attached to a respective one of the pair of endwalls.

9. The apparatus of claim 7, wherein each of the pair of endwalls defines a respective curved edge.

10. The apparatus of claim 7, wherein the pair of endwalls have different dimensions from each other.

11. The apparatus of claim 1, further comprising a second cord passing through the handle.

12. The apparatus of claim 11, wherein the second cord is elastic.

13. The apparatus of claim 12, further comprising a pair of endwalls spanning between the pair of sidewalls, wherein the second cord biases the handle towards one of the pair of endwalls when stretched.

14. The apparatus of claim 1, further comprising a belt passing through the pair of sidewalls.

15. The apparatus of claim 1, further comprising:
a tree trunk; and
a belt encircling the tree trunk and passing through the pair of sidewalls.

16. The apparatus of claim 15, further comprising an actuation cable attached to the handle.

17. The apparatus of claim 16, further comprising a pair of endwalls spanning between the pair of sidewalls, wherein the actuation cable rides over a top edge of one of the pair of endwalls.

18. The apparatus of claim 16, wherein pulling the actuation cable causes the handle to translate in the pair of tracks.
